(19) United States
(12) Patent Application Publication
(10) Pub. No.: US 2016/0290099 A1
(43) Pub. Date: Oct. 6, 2016

(54) SHAPE MEMORY MATERIAL GAS LIFT VALVE ACTUATOR

(71) Applicant: Schlumberger Technology Corporation, Sugar Land, TX (US)

(72) Inventor: Ganesh Balasubramanian, Missouri City, TX (US)

(21) Appl. No.: 15/085,812

(22) Filed: Mar. 30, 2016

Related U.S. Application Data
(60) Provisional application No. 62/141,564, filed on Apr. 1, 2015.

(51) Int. Cl. E21B 34/06; F16K 31/02; F03G 7/06

(52) U.S. Cl. CPC E21B 34/066; F03G 7/065; F16K 31/025

(57) ABSTRACT

A method can include altering heat energy of a shape memory material of a shape memory material actuator operatively coupled to a valve mechanism of a gas lift valve; responsive to the altering, adjusting the valve mechanism at least in part via the shape memory material actuator; altering heat energy of the shape memory material; and adjusting the valve mechanism at least in part via the shape memory material actuator.

### RELATED APPLICATIONS

This application claims the benefit of and priority to U.S. Provisional Application Ser. No. 62/141,564, filed 1 Apr. 2015, which is incorporated by reference herein.

### BACKGROUND

A gas lift valve may be implemented in a gas lift system, for example, to control flow of lift gas into a production tubing conduit. As an example, a gas lift valve may be located in a gas lift mandrel, which may provide for communication with a lift gas supply, for example, in an annulus (e.g., between production tubing and casing). Operation of a gas lift valve may be determined, for example, by preset opening and closing pressures in the tubing or annulus.

### SUMMARY

A gas lift valve can include a shape memory material actuator; and a valve member operatively coupled to the shape memory material actuator. A system can include a gas lift valve that includes a shape memory material actuator and an electrical connector; and a mandrel that includes circuitry and an electrical connector that electrically connects the circuitry to the electrical connector of the gas lift valve. A method can include altering heat energy of a shape memory material of a shape memory material actuator operatively coupled to a valve mechanism of a gas lift valve; responsive to the altering, adjusting the valve mechanism at least in part via the shape memory material actuator; altering heat energy of the shape memory material; and adjusting the valve mechanism at least in part via the shape memory material actuator.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a system and an example of a method;

FIG. 2 illustrates an example of a system;

FIG. 3 illustrates an example of a gas lift valve;

FIGS. 4A and 4B illustrate the gas lift valve of FIG. 3;

FIG. 5 illustrates an example of a plot;

FIG. 6 illustrates an example of a shape memory material actuator;

FIG. 7 illustrates examples of states of the shape memory material actuator of FIG. 6;

FIG. 8 illustrates examples of plots;

FIG. 9 illustrates an example of a shape memory material actuator;

FIG. 10 illustrates examples of states of the shape memory material actuator of FIG. 9;

FIG. 11 illustrates an example of a shape memory material actuator;

FIG. 12 illustrates an example of a shape memory material actuator;

FIG. 13 illustrates an example of a shape memory material actuator;

FIG. 14 illustrates an example of a shape memory material actuator;

FIG. 15 illustrates an example of a system;

FIG. 16 illustrates an example of a system;

FIG. 17 illustrates an example of a system; and

FIG. 18 illustrates an example of a method.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Gas lift is a process where, for example, gas may be injected from an annulus into tubing. An annulus, as applied to an oil well or other well for recovering a subsurface resource may refer to a space, lumen, or void between piping, tubing or casing and the piping, tubing, or casing immediately surrounding it, for example, at a greater radius.

As an example, injected gas may aerate well fluid in production tubing in a manner that “lightens” the well fluid such that the fluid can flow more readily to a surface location. As an example, one or more gas lift valves may be configured to control flow of gas during an intermittent flow or a continuous flow gas lift operation. As an example, a gas lift valve may operate based at least in part on a differential pressure control that can actuate a valve mechanism of the gas lift valve.

As gas lift valve may include a so-called hydrostatic pressure chamber that, for example, may be charged with a desired pressure of gas (e.g., nitrogen, etc.). As an example, an injection-pressure-operated (IPO) gas lift valve or an unloading valve can be configured so that an upper valve in a production string opens before a lower valve in the production string opens.

As an example, a gas lift valve may be configured, for example, in conjunction with a mandrel, for placement and/or retrieval of the gas lift valve using a tool. For example, consider a side pocket mandrel that is shaped to allow for installation of one or more components at least partially in a side pocket or side pockets where a production flow path through the side pocket mandrel may provide for access to a wellbore and completion components located below the side pocket mandrel. As an example, a side pocket mandrel can include a main axis and a pocket axis where the pocket axis is offset a radial distance from the main axis. In such an example, the main axis may be aligned with production tubing, for example, above and/or below the side pocket mandrel.

As an example, a tool may include an axial length from which a portion of the tool may be kicked-over (e.g., to a kicked-over position). In such an example, the tool may include a region that can carry a component such as a gas lift valve. An installation process may include inserting a length of the kickover tool into a side pocket mandrel (e.g., along a main axis) and kicking over a portion of the tool that carries a component toward the side pocket of the mandrel to thereby facilitate installation of the component in the side pocket. A removal process may operate in a similar manner, however, where the portion of the tool is kicked-over to facilitate latching to a component in a side pocket of a side pocket mandrel.

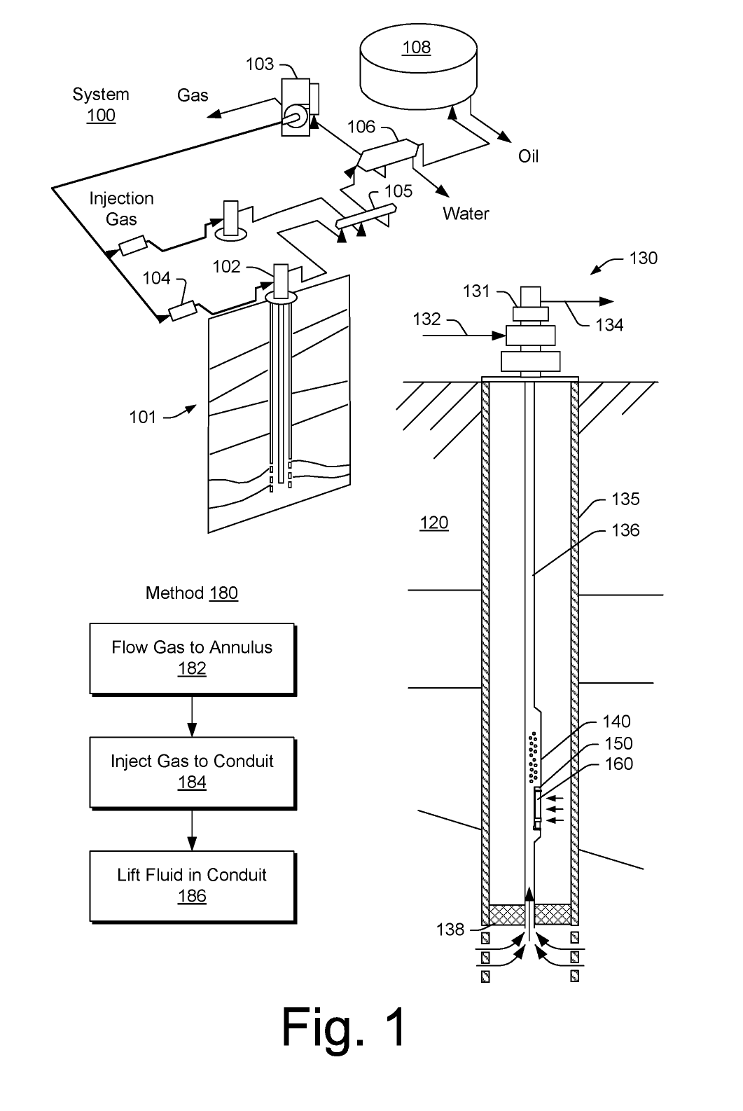

FIG. 1 shows an example of a system 100, an example of a geologic environment 120 that includes equipment and an example of a method 180. The system 100 includes a subterranean formation 101 with a well 102. Injection gas is provided to the well 102 via a compressor 103 and a regulator 104. The injection gas can assist with lifting fluid that flows from the subterranean formation 101 to the well 102. The lifted fluid, including injected gas, may flow to a manifold 105, for example, where fluid from a number of wells may be combined. As shown in the example of FIG. 1, the manifold 105 is operatively coupled to a separator 106, which may separate components of the fluid. For example, the separator 106 may separate oil, water and gas components as substantially separate phases of a multiphase fluid. In such an example, oil may be directed to an oil storage facility 108 while gas may be directed to the compressor 103, for example, for re-injection, storage and/or transport to another location. As an example, water may be directed to a water discharge, a water storage facility, etc.

As shown in FIG. 1, the geologic environment 120 is fitted with well equipment 130, which includes a well-head 131 (e.g., a Christmas tree, etc.), an inlet conduit 132 for flow of compressed gas, an outlet conduit 134 for flow of produced fluid, a casing 135, a production conduit 136, and a packer 138 that forms a seal between the casing 135 and the production conduit 136. As shown, fluid may enter the casing 135 (e.g., via perforations) and then enter a lumen of the production conduit 136, for example, due to a pressure differential between the fluid in the subterranean geologic environment 120 and the lumen of the production conduit 136 at an opening of the production conduit 136. Where the inlet conduit 132 for flow of compressed gas is used to flow gas to the annular space between the casing 135 and the production conduit 136, a mandrel 140 operatively coupled to the production conduit 136 that includes a pocket 150 that seats a gas lift valve 160 that may regulate the introduction of the compressed gas into the lumen of the production conduit 136. In such an example, the compressed gas introduced may facilitate flow of fluid upwardly to the well-head 131 (e.g., opposite a direction of gravity) where the fluid may be directed away from the well-head 131 via the outlet conduit 134.

As shown in FIG. 1, the method 180 can include a flow block 182 for flowing gas to an annulus (e.g., or, more generally, a space exterior to a production conduit fitted with a gas lift valve), an injection block 184 for injecting gas from the annulus into a production conduit via a gas lift valve or gas lift valves and a lift block 186 for lifting fluid in the production conduit due in part to buoyancy imparted by the injected gas.

As an example, where a gas lift valve includes one or more actuators (e.g., one or more shape memory material actuators, etc.), such actuators may optionally be utilized to control, at least in part, operation of a gas lift valve (e.g., one or more valve members of a gas lift valve). As an example, surface equipment can include one or more control lines that may be operatively coupled to a gas lift valve or gas lift valves, for example, where a gas lift valve may respond to a control signal or signals via the one or more control lines. As an example, surface equipment can include one or more power lines that may be operatively coupled to a gas lift valve or gas lift valves, for example, where a gas lift valve may respond to power delivered via the one or more power lines. As an example, a system can include one or more control lines and one or more power lines where, for example, a line may be a control line, a power line or a control and power line.

As an example, a production process may optionally utilize one or more fluid pumps such as, for example, an electric submersible pump (e.g., consider a centrifugal pump, a rod pump, etc.). As an example, a production process may implement one or more so-called “artificial lift” technologies. An artificial lift technology may operate by adding energy to fluid, for example, to initiate, enhance, etc. production of fluid.

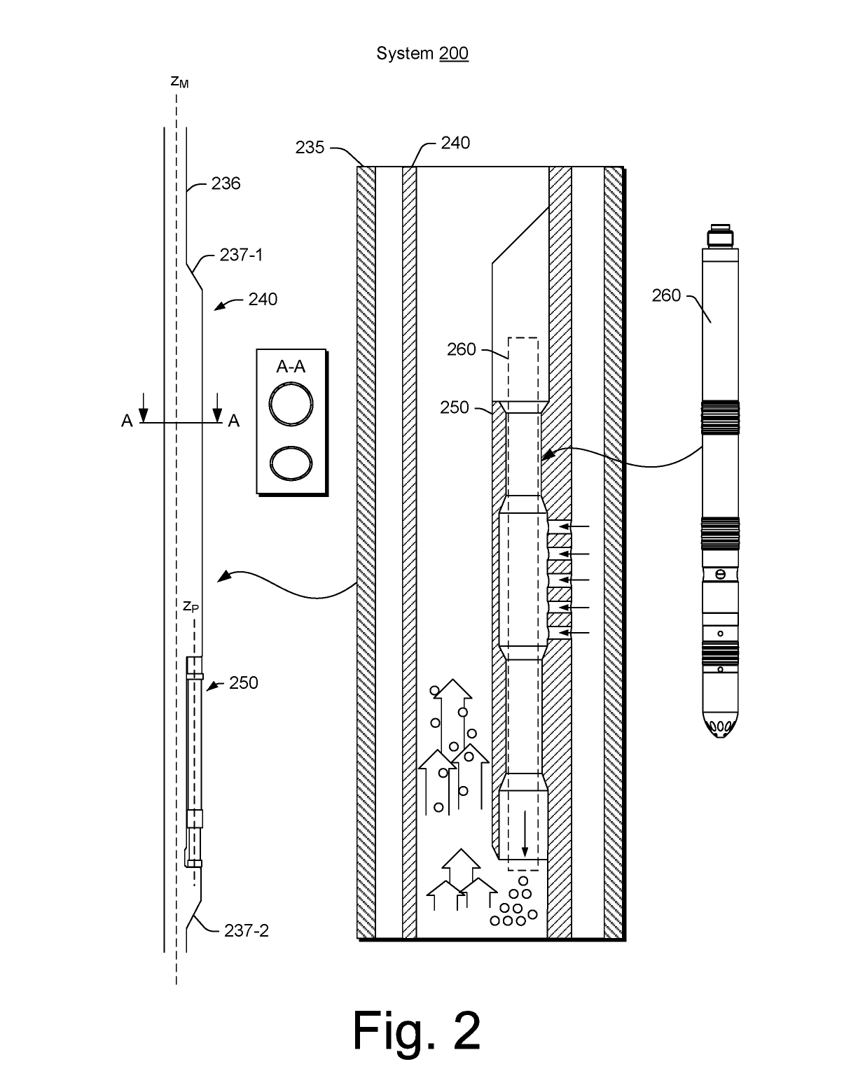

FIG. 2 shows an example of a system 200 that includes a casing 235, a production conduit 236 and a mandrel 240 that includes a pocket 250 that seats a gas lift valve 260. As shown, the mandrel 240 can include a main longitudinal axis (z_{M}) and a side pocket longitudinal axis (z_{P}) that is offset a radial distance from the main longitudinal axis (z_{M}). In the example of FIG. 2, the axes (z_{M} and z_{P}) are shown as being substantially parallel such that a bore of the pocket 250 is parallel to a lumen of the mandrel 240. Also shown in FIG. 2 are two examples of cross-sectional profiles for the mandrel 240, for example, along a line A-A. As shown, a mandrel may include a circular cross-sectional profile or another shaped profile such as, for example, an oval profile.

As an example, a completion may include multiple instances of the mandrel 240, for example, where each pocket of each instance may include a gas lift valve where, for example, one or more of the gas lift valves may differ in one or more characteristics from one or more other of the gas lift valves (e.g., pressure settings, etc.).

As shown in the example of FIG. 2, the mandrel 240 can include one or more openings that provide for fluid communication with fluid in an annulus (e.g., gas and/or other fluid), defined by an outer surface of the mandrel 240 and an inner surface of the casing 235, via a gas lift valve 260 disposed in the pocket 250. For example, the gas lift valve 260 may be disposed in the pocket 250 where a portion of the gas lift valve 260 is in fluid communication with an annulus (e.g., with casing fluid) and where a portion of the gas lift valve 260 is in fluid communication with a lumen (e.g., with tubing fluid). In such an example, fluid may flow from the annulus to the lumen (e.g., bore) to assist with lift of fluid in the lumen or, for example, fluid may flow from the lumen to the annulus. The pocket 250 may include an opening that may be oriented downhole and one or more openings that may be oriented in a pocket wall, for example, directed radially to a lumen space. As an example, the pocket 250 may include a production conduit lumen side opening (e.g., an axial opening) for placement, retrieval, replacement, adjustment, etc. of a gas lift valve. For example, through use of a tool, the gas lift valve 260 may be accessed. As an example, where a gas lift valve includes circuitry such as a battery or batteries, a tool may optionally provide for charging and/or replacement of a battery or batteries.

In the example of FIG. 2, gas is illustrated as entering from the annulus to the gas lift valve 260 as disposed in the pocket 250. Such gas can exit at a downhole end of the gas lift valve 260 where the gas can assist in lifting fluid in the lumen of the mandrel 240 (e.g., as supplied via a bore of production tubing, etc.).

As an example, a side pocket mandrel may be configured with particular dimensions, for example, according to one or more dimensions of commercially available equipment. As an example, a side pocket mandrel may be defined in part by a tubing dimension (e.g., tubing size). For example, consider tubing sizes of about 2.375 in (e.g., about 60 mm), of about 2.875 in (e.g., about 73 mm) and of about 3.5 in (e.g., about 89 mm). As to types of valves that may be suitable for installation in a side pocket mandrel, consider dummy valves, shear orifice valves, circulating valves, chemical injection valves and waterflood flow regulator valves. As an example, a side pocket may include a bore configured for receipt of a device that includes an outer diameter of about 1 in (e.g., about 25 mm), or about 1.5 in. (e.g., about 37 mm) or more. As mentioned, a running tool, a pulling tool, a kickover tool, etc. may be used for purposes of installation, retrieval, adjustment, etc. of a device with respect to a side pocket. As an example, a tool may be positionable via a slickline technique.

As an example, a side pocket mandrel may include a circular and/or an oval cross-sectional profile (e.g., or other shaped profile). As an example, a side pocket mandrel may include an exhaust port (e.g., at a downhole end of a side pocket).

As an example, a mandrel may be fit with a gas lift valve that may be, for example, a valve according to one or more specifications such as an injection pressure-operated (IPO) valve specification. As an example, a positive-sealing check valve may be used such as a valve qualified to meet API-19G1 and G2 industry standards and pressure barrier qualifications. For example, with a test pressure rating of about 10,000 psi (e.g., about 69,000 kPa), a valve may form a metal-to-metal barrier between production tubing and a casing annulus that may help to avoid undesired communication (e.g., or reverse flow) and to help mitigate risks associated with gas lift valve check systems.

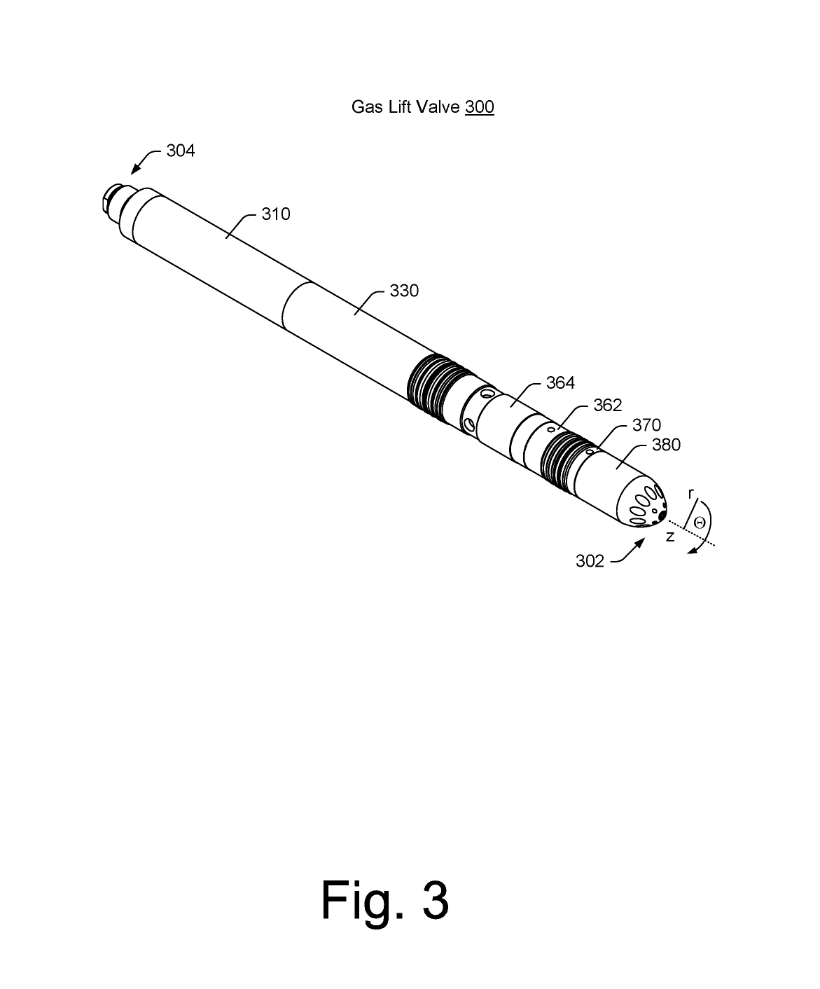

FIG. 3 shows an example of a gas lift valve 300 that includes a gas outlet end 302, a tool end 304, a control gas chamber section 310, a bellows valve mechanism section 330, a coupling 362, a gas inlet section 364, a coupling 370 and a gas outlet section 380. Various features of the gas lift valve 300 may be described with respect to a cylindrical coordinate system (e.g., r, z, Θ) where, for example, a z-axis represents a longitudinal axis of the gas lift valve 300, a r-axis represents a distance from the z-axis (e.g., radially outwardly) and an azimuthal angle (Θ) represents an azimuthal position of a feature, for example, with respect to a feature that may be deemed to be at 0 degrees (e.g., a reference feature such as an opening, etc.).

In the example of FIG. 3, the gas lift valve 300 can include a plurality of seal elements, for example, to seal against a bore of a mandrel in which at least a portion of the gas lift valve 300 may be disposed. As an example, a seal element or seal elements may act to form a seal between an outer surface of a gas lift valve and an inner surface of a bore of a mandrel where such a seal may be disposed between a gas inlet opening and a gas outlet opening of the gas lift valve. As an example, seal elements may be ring shaped and, for example, at least in part seated in one or more annular grooves of an outer surface of a gas lift valve. As an example, a gas lift valve can include a plurality of internal seal elements.

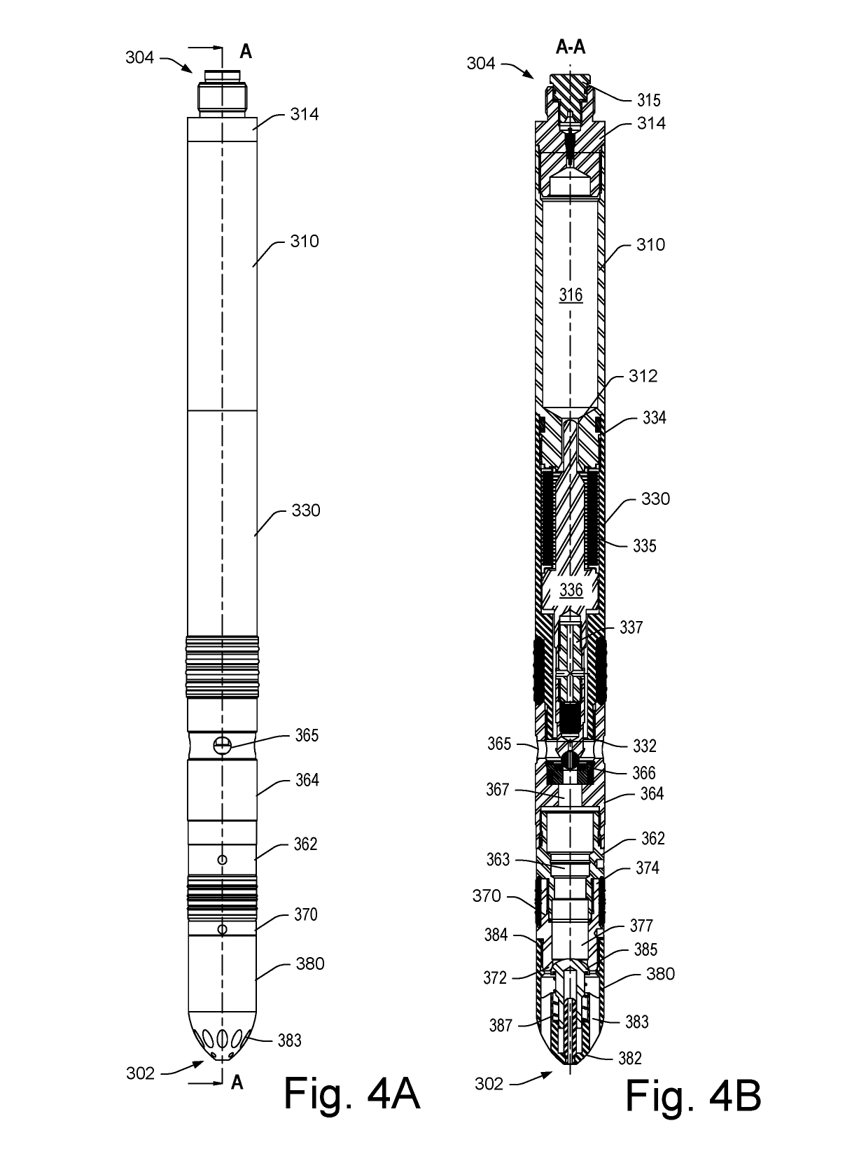

FIG. 4A shows a side view of the gas lift valve 300 and FIG. 4B shows a cutaway view of the gas lift valve 300 along a line A-A. As shown in FIG. 4A, the gas inlet section 364 includes at least one opening 365 as a gas inlet (see, e.g., the arrangement of FIG. 2) and the gas outlet section 380 includes at least one opening 383 as a gas outlet.

FIG. 4B shows the control gas chamber section 310 as including a piston bore 312 and a plug 314 at opposing ends of a gas chamber 316, which may be charged with gas such as nitrogen. In the example of FIG. 4B, a seal plug 315 may be utilized to seal a passage in the plug 314, for example, after charging the gas chamber 316 to a desired gas pressure.

FIG. 4B shows the bellows valve mechanism section 330 as including opposing ends 332 and 334, a bellows 335, a piston 336 and a valve member 337. In the example of FIG. 4B, the bellows 335 may be sealed with respect to the bellows 335 and the chamber 316. In such an example, the one or more openings 365 of the gas inlet section 364 can communicate gas pressure that can act upon the valve member 337. In such an example, where the pressure is sufficiently high (e.g., with respect to pressure in the chamber 316), force exerted may cause the valve member 337 and the piston 336 to translate toward the chamber 316. In such an example, the valve member 337 may retract from a valve seat 366 that is supported by the gas inlet section 364. As shown, the valve seat 366 is annular such that an opening defined thereby can allow for flow of gas to a bore 367 of the gas inlet section 364.

In the example of FIG. 4B, the coupling 362 includes a bore 363 that is in fluid communication with the bore 367 and that is in fluid communication with a bore 377 of the coupling 370 such that gas pressure can act upon a check valve member 385 supported by the gas outlet section 380, which may be seated against an end 372 of the coupling 370, which has an opposing end 374. For example, the check valve member 385 may include a translatable dome shape that can seat against an annular check valve seat defined by the end 372 of the coupling 370.

In the example of FIG. 4B, the check valve member 385 can be biased by a biasing member 387, which may be, for example, a spring. Where gas pressure in the bore 377 of the coupling 370 is sufficiently high, force acting on the check valve member 385 may cause compression of the biasing member 387 and translation of the check valve member 385 downwardly away from the gas inlet section 364 such that the one or more openings 365 of the gas inlet section 364 become in fluid communication with the one or more openings 383 of the gas outlet section 380.

As an example, the check valve member 385 may be referred to as a dart. As an example, the check valve member 385 may be considered to be a low pressure valve member; whereas, the valve member 337 may be considered to be a high pressure valve member. As an example, a valve member can include a ball that can be seated in a valve seat to plug an opening in the valve seat.

As an example, a gas lift valve can include one or more shape memory materials. For example, consider a shape memory alloy that is an alloy that “remembers” a shape and that when deformed returns to its pre-deformed shape responsive to a stimulus such as, for example, an electric current and/or heat.

As an example, a shape memory material may be utilized as part of a mechanism of an actuator. For example, a shape memory material may respond to a condition or conditions to transition from one shape to another shape. For example, a shape memory material may be deformed in one state and then transitioned toward an un-deformed state in response to an electric current (e.g., and/or heat). In such an example, the shape memory material can be a material that can transition from one state toward another state and vice-versa such that actuation may be accomplished in a controllable or otherwise predictable and desirable manner.

Some examples of shape memory alloys include copper-aluminum-nickel alloys and nickel-titanium (NiTi) alloys. Such types of shape memory alloys may be referred to as classes or families (e.g., a Cu—Al—Ni family and a NiTi family). However, shape-memory alloys can also be created, for example, by alloying zinc, copper, gold and iron. As an example, an actuator may employ one or more types of shape memory alloys.

As to some particular examples of shape memory alloys, consider the following: Ag—Cd (e.g., with about 44-49 at % Cd); Au—Cd (e.g., with about 46.5-50 at % Cd); Cu—Al—Ni (e.g., with about 14-14.5 wt % Al and about 3-4.5 wt % Ni), Cu—Sn (e.g., containing about 15 at % Sn); Cu—Zn (e.g., with about 38.5-41.5 wt % Zn); Cu—Zn—Si; Cu—Zn—Al; Cu—Zn—Sn; Fe—Pt (e.g., with about 25 at % Pt); Mn—Cu (e.g., with about 5-35 at % Cu); Fe—Mn—Si; Co—Ni—Al; Co—Ni—Ga; Ni—Fe—Ga; Ti—Nb; Ni—Ti (e.g., with about 55-60 wt % Ni); Ni—Ti—Hf; Ni—Ti—Pd; and Ni—Mn—Ga. As an example, a combination of different types of shape memory materials may be utilized in an actuator or actuators.

As an example, a shape memory material can include material that can be characterized by a phase or phases. For example, various shape memory materials can exist in two different phases, with three different crystal structures (e.g., twinned martensite, detwinned martensite and austenite) and six possible transformations.

As an example, NiTi-based shape memory materials may offer a desired amount of stability, practicability and superior thermo-mechanic performance for particular applications.

As an example, a shape memory material actuator can include one or more elements that are made of shape memory material, which may be, for example, in the form of a wire, a coil, a ribbon, etc. As an example, shape memory material may be included in an actuator to operate in one or more manners. For example, consider a unidirectional manner where force is directed in a single direction upon actuation or, for example, consider a bidirectional manner where some shape memory material may be arranged to be actuated to apply force in one direction and where some shape memory material may be arranged to be actuated to apply force in another direction, which may be an opposing direction. As an example, shape memory material may be arranged to operate in a plurality of directions. As an example, shape memory material may optionally be arranged to operate antagonistically, for example, in antagonistic pairs, etc.

As an example, shape memory material may be heated via joule heating where, for example, electrical current is passed through the shape memory material. Joule heating, which may be referred to as ohmic heating or resistive heating, is a process by which passage of an electric current through a conductive material generates heat energy, which may cause a rise in temperature of the conductive material (e.g., depending on heat transfer, etc.). As an example, joule heating can occur with direct current (DC) and/or with alternating current (AC). Joule heating tends to be independent of the direction of current in a conductive material.

As an example, shape memory material may be cooled via heat transfer to surroundings (e.g., via conduction and optionally convection). As an example, a mechanism may allow for cooling via flow of fluid, for example, via convection of a fluid that may flow responsive to operation of a valve or valves. As an example, heating and/or cooling may be controlled via one or more approaches (e.g., size, environment, application of current, amount of current, a changing rate of current, etc.). As an example, current can be direct current (DC). As an example, heating and/or cooling rates may determine rate of transitions from one shape to another shape of shape memory material. As an example, a plurality of thin elements may be utilized for more rapid response as to thermal effects whereas a thicker element may be utilized for a slower response as to thermal effects where, for example, the plurality of thin elements and the thicker element may be able to exert about the same amount of force.

As an example, shape memory material may be fitted with one or more sensors, for example, to measure temperature, strain, position, etc. As an example, circuitry that can actuate shape memory material may receive sensed information and control shape memory material based at least in part on such sensed information.

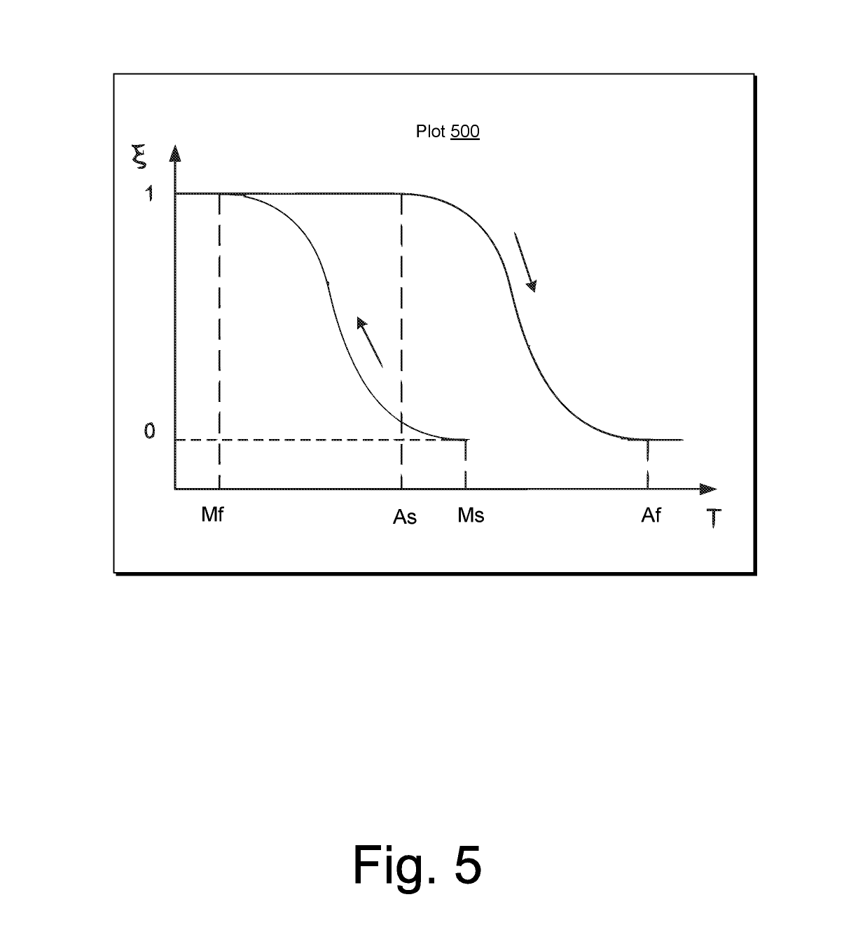

FIG. 5 shows an example of a plot 500 for NiTi-based shape memory material that can change from austenite to martensite upon cooling. In the plot 500, Mf is the temperature at which the transition to martensite completes upon cooling. As indicated in the plot 500, during heating, As and Af are the temperatures at which the transformation from martensite to austenite starts and finishes. Repeated use of the shape-memory effect may lead to a shift of the characteristic transformation temperatures (e.g., an effect known as functional fatigue, as may be related with a change of microstructural and functional properties of the material). The maximum temperature at which a shape memory alloy can no longer be stress induced is called Md. In some instances, shape memory alloy may be considered to be permanently deformed when it can no longer be stress induced.

As illustrated in the plot 500 of FIG. 5, the transition from the martensite phase to the austenite phase depends on temperature and, it can also depend on stress. The austenite structure receives its name from steel alloys of a similar structure. A reversible diffusionless transition between these two phases can result in particular shape memory properties. While martensite can be formed from austenite by rapidly cooling carbon-steel, as this process is not reversible, steel does not tend to possess shape-memory properties.

Referring again to the plot 500 of FIG. 5, (T) represents the martensite fraction of a shape memory material (e.g., a NiTi-based shape memory alloy). As indicated in the plot 500, a difference between the heating transition and the cooling transition gives rise to hysteresis where some of the mechanical energy is lost in the process. The shape of the curve depends on the material properties of the shape memory material (e.g., consider alloying and work hardening).

As an example, a shape memory material can exhibit different shape memory effects. For example, consider one-way and two-way shape memory effects. As an example, a shape memory material may exhibit superelasticity, which can be characterized by recovery of unusually large strains. As an example, consider a shape memory material that, instead of transforming between the martensite and austenite phases in response to temperature, the phase transformation is induced in response to mechanical stress. As an example, when such a shape memory material is loaded in the austenite phase, the material may transform to the martensite phase above a critical stress, for example, proportional to the transformation temperatures. In such an example, upon continued loading, the twinned martensite may begin to detwin, allowing the material to undergo large deformations. In such an example, once the stress is released, the martensite may transform back to austenite such that the material recovers its “original” shape. As an example, such materials may reversibly deform to very high strains (e.g., up to 8 percent or more).

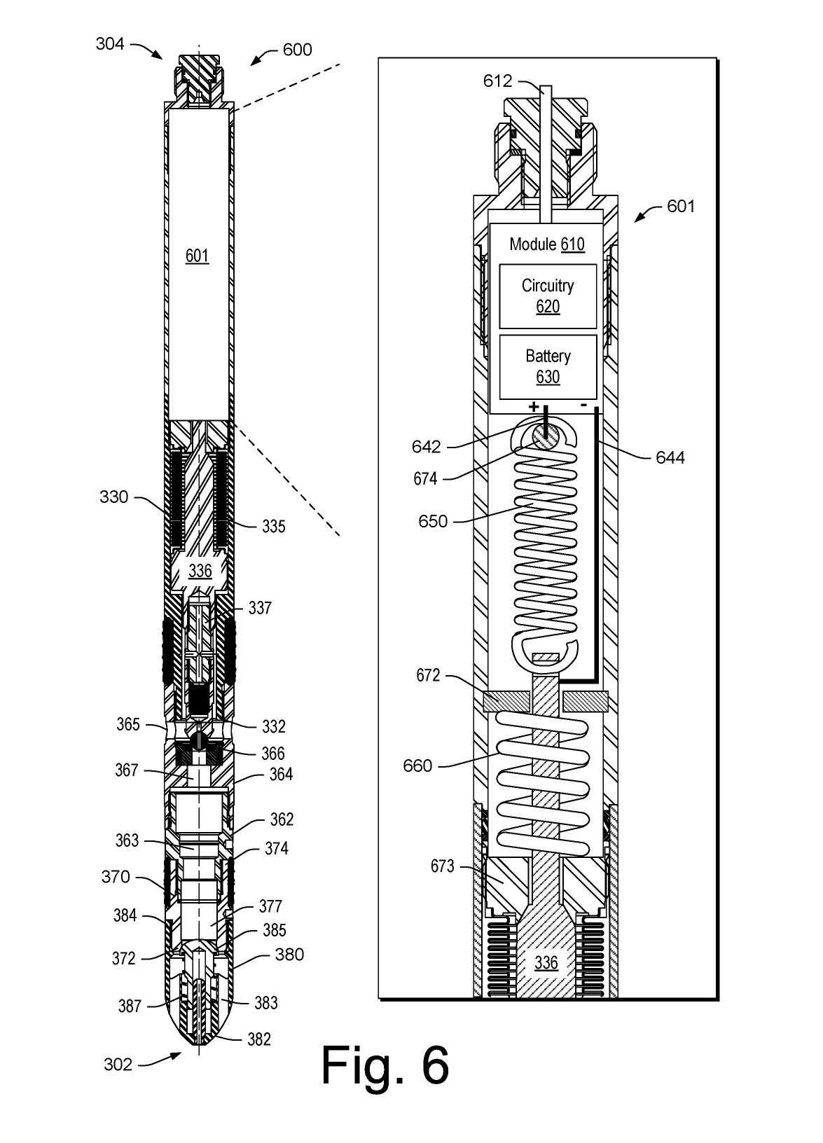

FIG. 6 shows an example of a gas lift valve 600 that can include various components of the gas lift valve 300 and a shape memory material actuator 601 that can adjust a valve mechanism of the gas lift valve 600. For example, the shape memory material actuator 601 may replace various components associated with the gas chamber 316 or, for example, a shape memory material actuator may supplement a gas chamber-based mechanism and/or provide an operational alternative to a gas chamber-based mechanism.

As shown in FIG. 6, the shape memory material actuator 601 includes a module 610 that can include one or more leads 612 or, for example, an access port or ports. As shown, the module 610 can include circuitry 620 and a battery 630, which may be a rechargeable battery (e.g., lithium-ion battery, etc.). The module 610 can include one or more current connectors 642 and 644 that can be electrically coupled to a shape memory material 650, which is shown as being shaped as a spring or, more generally, as a biasing element. While a single element is illustrated, as an example, a plurality of elements may be included, optionally in series and/or in parallel.

In the example of FIG. 6, at shape memory material 650 is secured at one end by a fixture 674 and free to move at another end (e.g., an opposing end) that is operatively coupled to the piston 336, which can be in contact with a spacer 673 or in contact with a biasing element 660. As shown, the biasing element 660 can be a spring (e.g., or springs, etc.) that is secured at one end by a fixture 672 and disposed axially between the fixture 672 and the spacer 673 where the biasing element 660 applies a biasing force (e.g., a spring force) that pushes the spacer 673 and the piston 336 axially away from the fixture 672. In such a manner, the force applied by the biasing element 660 can maintain the valve member 337 in contact with the valve seat 336 to keep the gas flow bore 367 in a closed state.

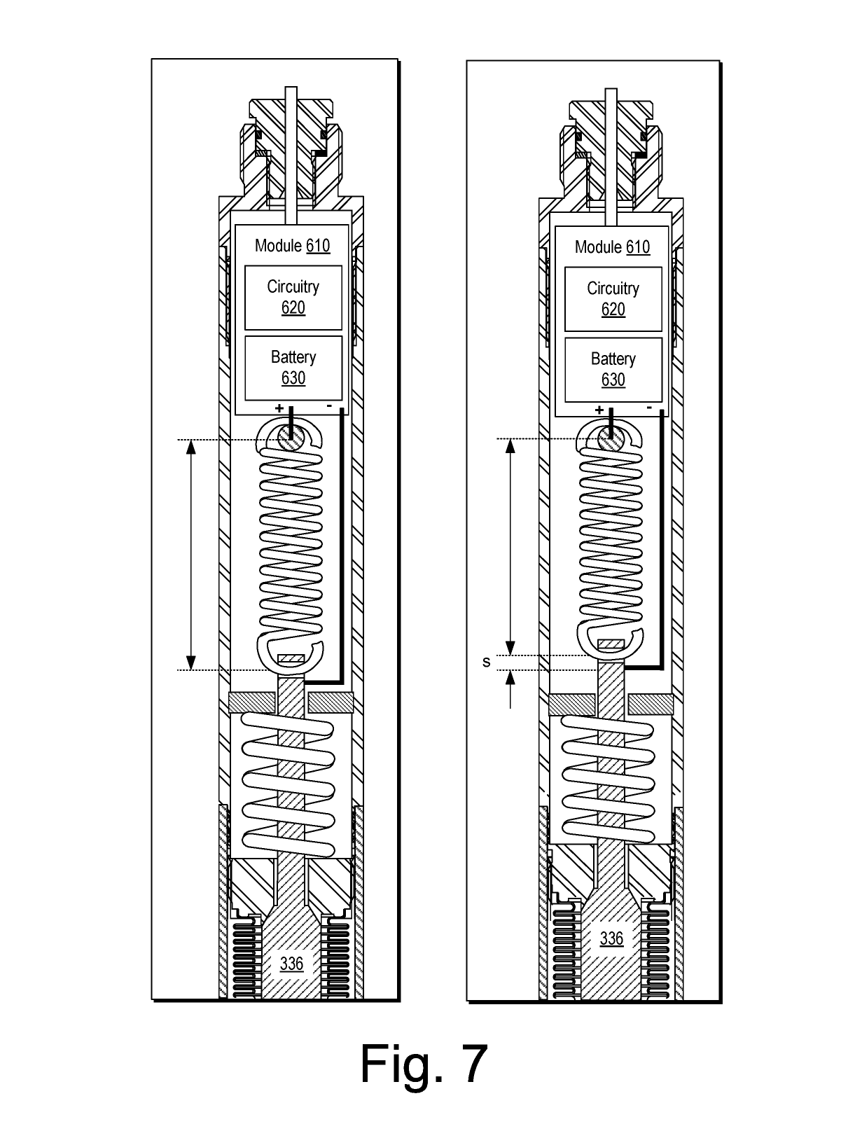

FIG. 7 shows the shape memory material 650 in two states that correspond to a close state of the gas flow bore 367 and an open state of the gas flow bore 367. In the example of FIG. 7, the shape memory material 650 may be considered to be a tensile element (e.g., or elements) such that, upon heating, the shape memory material 650 contracts to axially compress the biasing element 660 and translate the piston 336 axially toward the secured end of the shape memory material 650 as operatively coupled to the fixture 674.

As an example, heating of the shape memory material 650 may be accomplished via application of a current to the shape memory material 650. For example, the circuitry 620 can cause a switch to electrically connect the battery 630 (e.g., terminals of the battery) to one or more of the current connector 642 and 644 to cause current to flow through the shape memory material 650 and, via electrical resistance, generate heat that causes a rise in temperature of the shape memory material 650 such that a phase transition occurs that causes the shape memory material 650 to alter its shape in a manner that shortens its axial length.

In the gas lift valve 600, the axial shortening can correspond to a stroke distance (s) for the piston 336 where the stroke distance is sufficient to cause the valve member 337 to lift axially away from the valve seat 366 and thereby provide a clearance for gas to flow from the one or more openings 365 to the bore 367 and, for example, to the one or more openings 383. As an example, a stroke distance may be of the order of millimeters. For example, the diameter of the gas lift valve 600 may be about 1.5 inches (e.g., about 37 mm) and the stroke distance may be about 2 mm to about 10 mm (e.g., where the one or more openings 365 may have a diameter of about 10 mm).

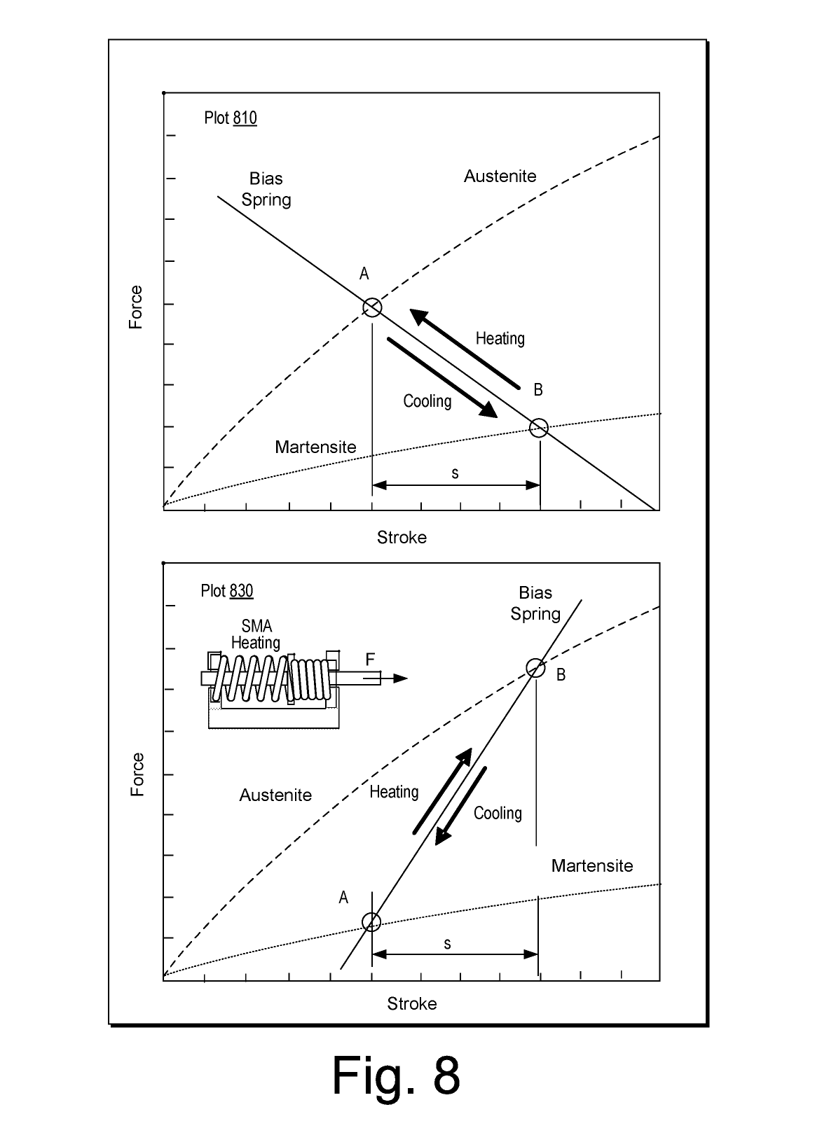

FIG. 8 shows an example of a plot 810 and an example of a plot 830 for a tensile spring arrangement and a compression spring arrangement, respectively. The tensile spring arrangement of the plot 810 can correspond to an arrangement such as that of the shape memory material actuator 601; whereas, a graphic in the plot 830 corresponds to a compression spring arrangement.

In the plot 810, heating can cause two springs to compress; whereas, in the plot 830, heating can cause one spring to lengthen (shape memory material biasing element) and another spring (e.g., non-shape memory material biasing element, etc.) to compress.

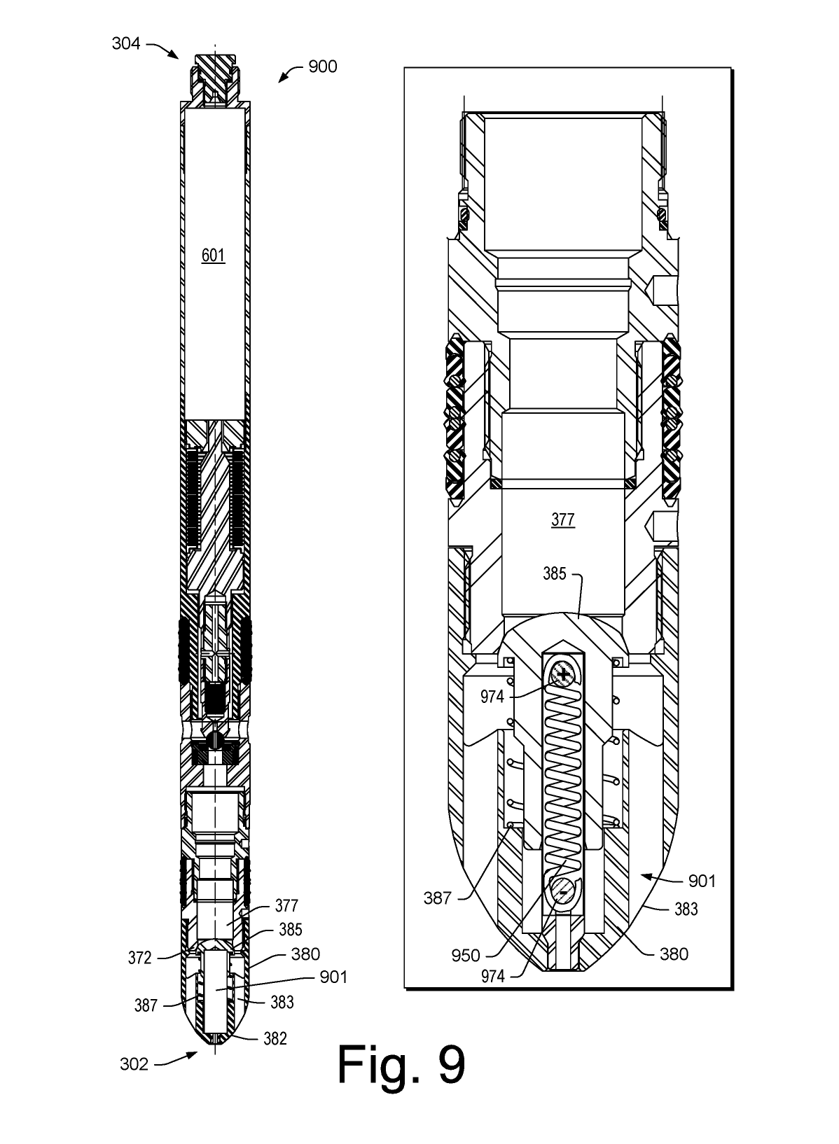

FIG. 9 shows an example of a gas lift valve 900 that can include various components of the gas lift valve 300 and a shape memory material actuator 901 that can adjust a valve mechanism of the gas lift valve 900; noting that such an example may include another shape memory material actuator such as the actuator 601.

The shape memory material actuator 901 may replace various components associated with the check valve member 385 or, for example, a shape memory material actuator may supplement a check valve mechanism and/or provide an operational alternative to a check valve mechanism.

In the example of FIG. 9, shape memory material 950 is shaped as a biasing element, which may be, for example, a spring; noting that one or more springs or other types of biasing elements may be arranged in series and/or in parallel. As shown, the shape memory material 950 is operatively coupled to two fixtures 972 and 974, which may be electrically connected to a power supply that can supply current to at least one of the fixtures 972 and 974 for flow of current through the shape memory material 950.

In the example of FIG. 9, the shape memory material 950 is biased by the spring 387 to be in a closed state. For example, the spring 387 can push the valve member 385 axially upwardly away such that it contacts a valve seat to seal the one or more openings 383. Where a current is supplied to the shape memory material 950, it may adjust its shape such that it axially shortens and applies a force in an axial direction that is opposite to the force applied by the spring 387. In such a manner, the valve member 385 may be drawn downwardly away from the valve seat to allow the bore 377 to be in fluid communication with the one or more openings 383.

As an example, a battery may be disposed in another portion of the gas lift valve 900; or, for example, a disc shaped battery (e.g., button battery, etc.) may be part of the valve member 385. For example, consider a dome shaped valve member where a base of the dome is a disc shaped battery that can be electrically coupled to a switch that can control supply of energy to shape memory material. As an example, one or more sections of a gas lift valve can include conductors that can electrically couple circuitry, which may be control circuitry, sensor circuitry, shape memory material (e.g., as a conductor), etc.

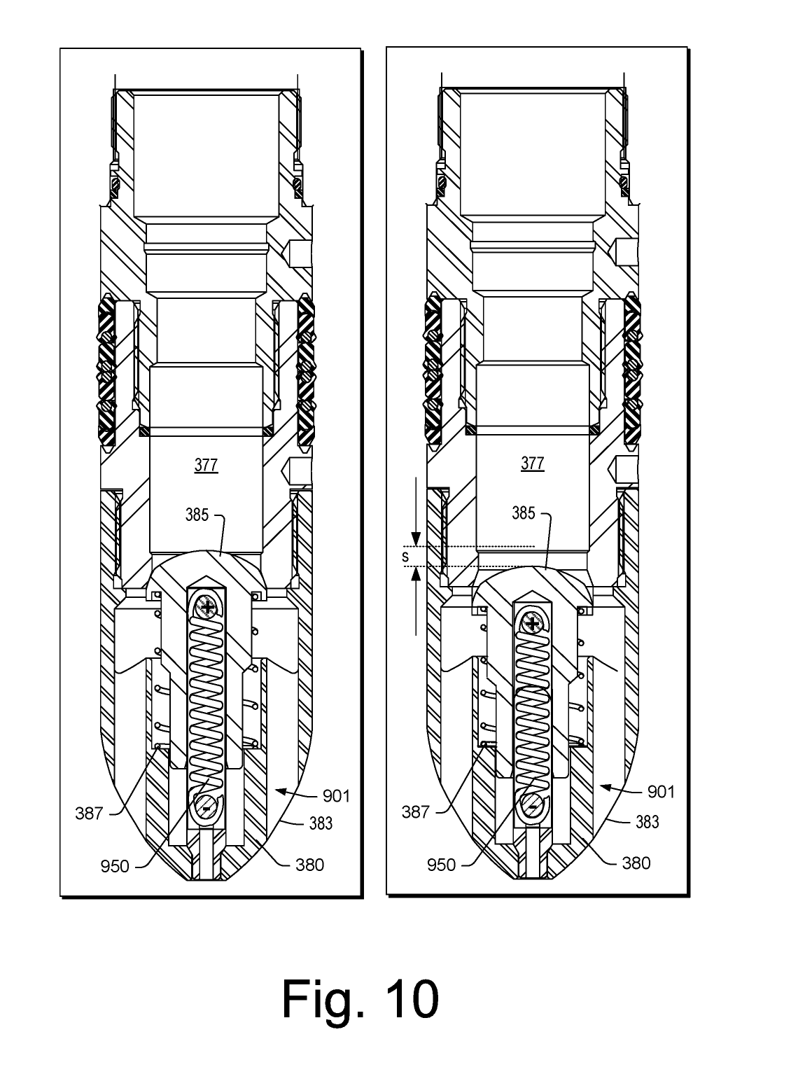

FIG. 10 shows the shape memory material actuator 901 in two states, a closed state on the left and an open state on the right. As shown in the example of FIG. 10, a stroke distance (s) can be sufficiently small to allow for gas to flow from the bore 377 to the one or more openings 383, which may be openings of corresponding bores that extend at least in part axially through the outlet section 380.

As an example, a stroke distance may be of the order of millimeters. For example, the diameter of the gas lift valve 900 may be about 1.5 inches (e.g., about 37 mm) and the stroke distance may be about 2 mm to about 10 mm.

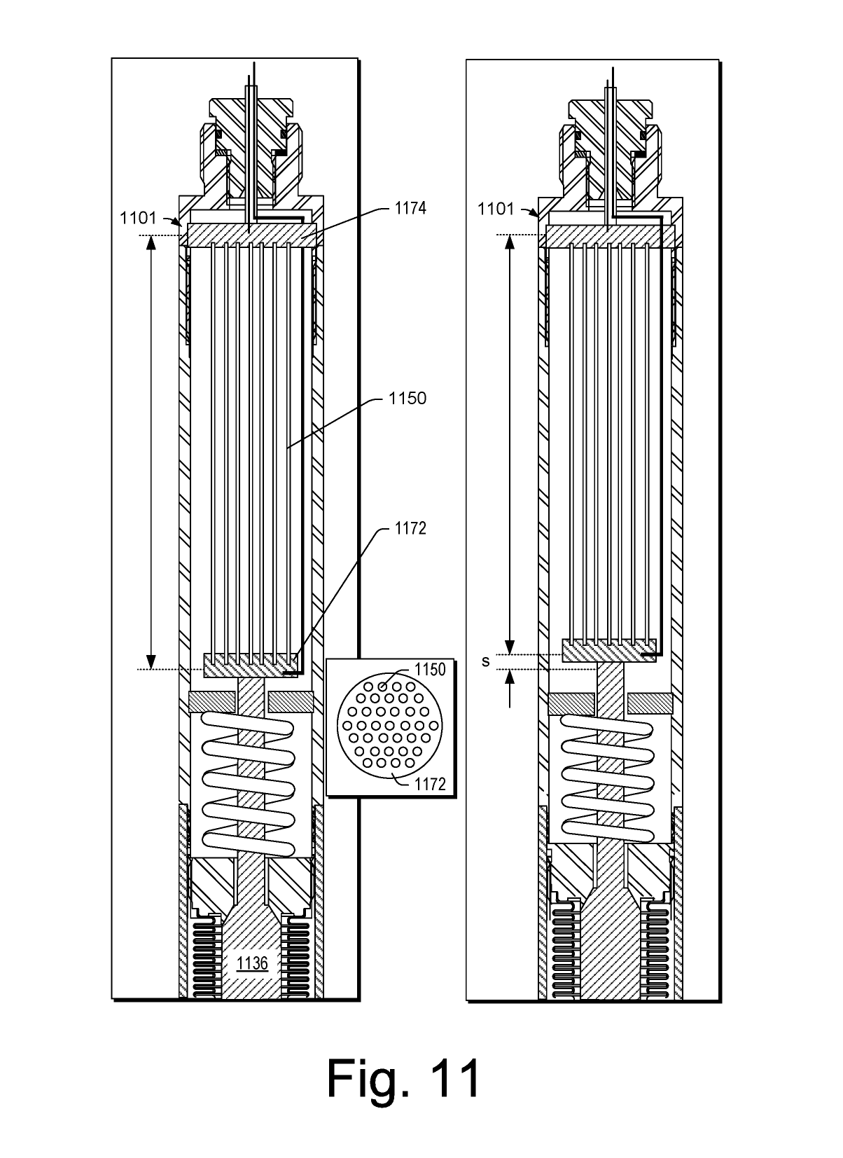

FIG. 11 shows an example of a shape memory material actuator 1101 that includes shape memory material 1150 that is operatively coupled to an end member 1172 and an end member 1174 where alteration in the shape of the shape memory material 1150 can translate a valve member 1136. For example, a current may be applied to the shape memory material 1150 to shorten lengths of a gang of wires such that the end member 1172 being operatively coupled to the valve member 1136 can translate upwards, for example, against force of a spring, a bellows chamber pressure, etc.

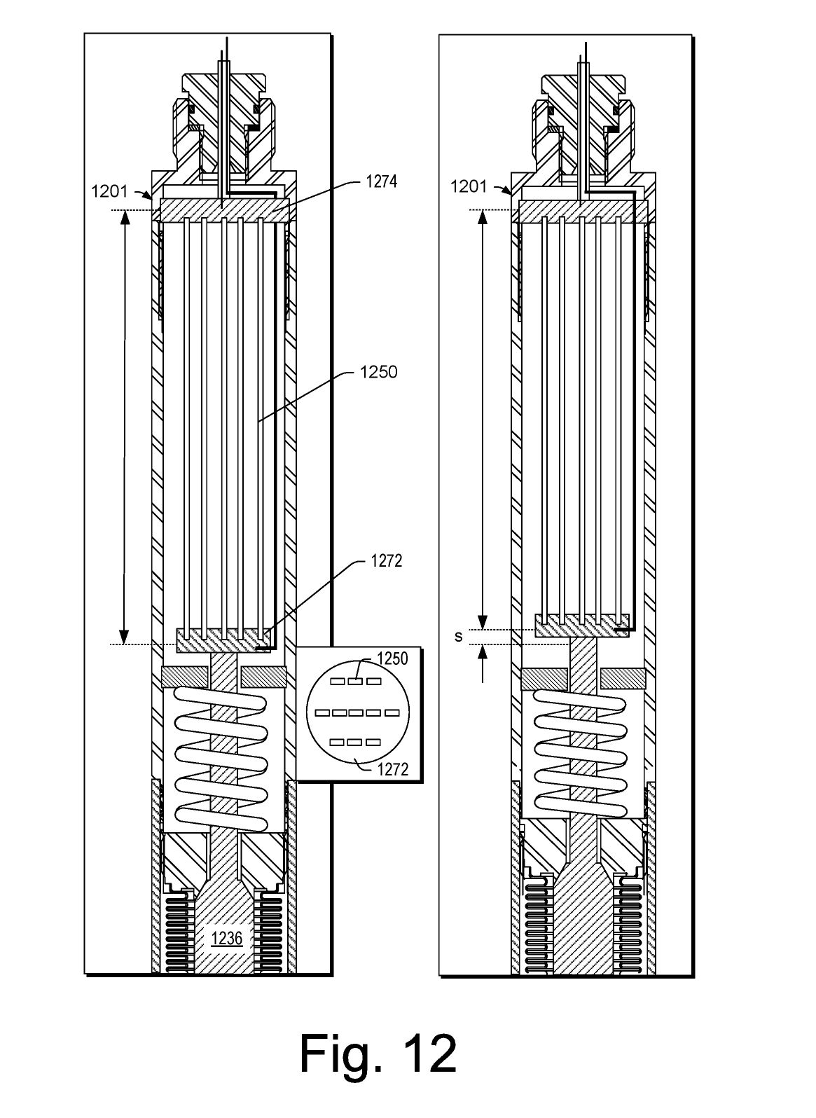

FIG. 12 shows an example of a shape memory material actuator 1201 that includes shape memory material 1250 that is operatively coupled to an end member 1272 and an end member 1274 where alteration in the shape of the shape memory material 1250 can translate a valve member 1236. For example, a current may be applied to the shape memory material 1250 to shorten lengths of a gang of ribbons such that the end member 1272 being operatively coupled to the valve member 1236 can translate upwards, for example, against force of a spring, a bellows chamber pressure, etc.

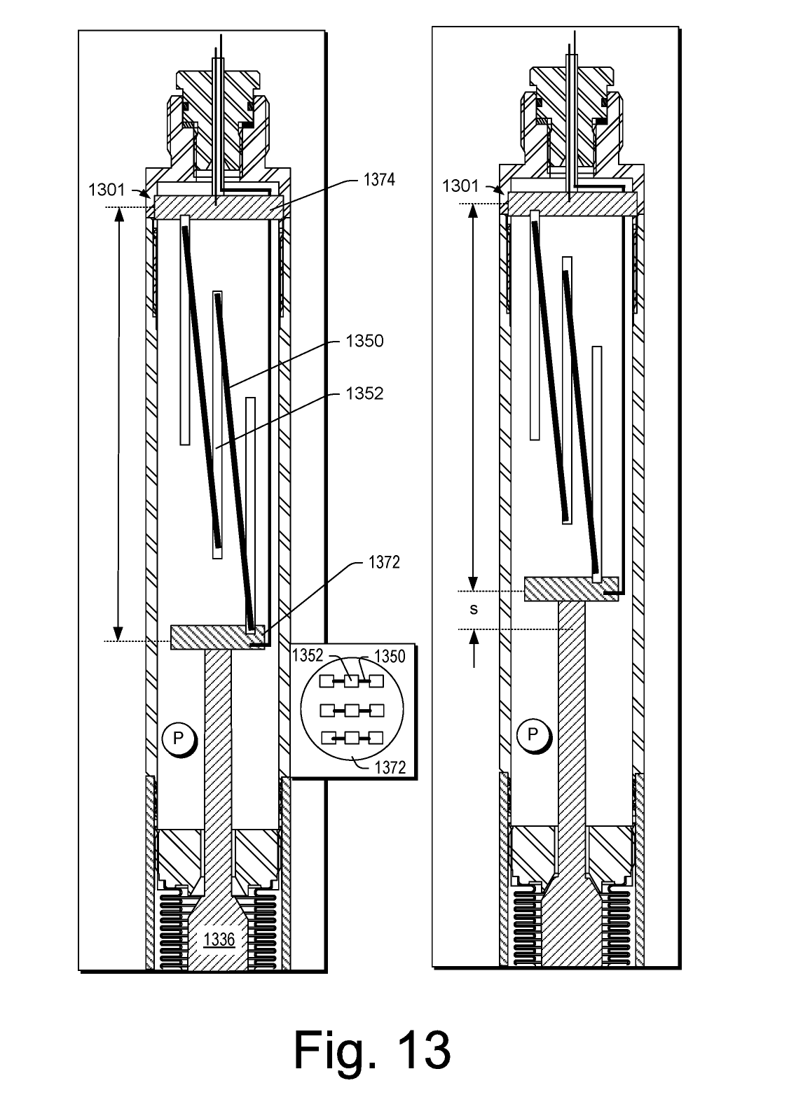

FIG. 13 shows an example of a shape memory material actuator 1301 that includes shape memory material 1350 that is operatively coupled links 1352, where at least one of the links 1352 is operatively coupled to an end member 1372 and where at least another of the links 1352 is operatively coupled to another end member 1374 where alteration in the shape of the shape memory material 1350 can translate a valve member 1336. For example, a current may be applied to the shape memory material 1350 to shorten the overall length of a gang of links 1352 such that the end member 1372 being operatively coupled to the valve member 1336 can translate upwards, for example, against force of a spring, a bellows chamber pressure, etc. In the example of FIG. 13, the shape memory material actuator 1301 can include a plurality of shape memory material and link sub-assemblies where, for example, at least one piece of shape memory material is disposed between two links.

In the example of FIG. 13, the shape memory material actuator 1301 can include a plurality of shape memory material and link sub-assemblies where, for example, at least one piece of shape memory material is disposed between two links. As an example, a link may be a rigid piece of material that may exhibit little to no deformation upon application of force via a change in shape or shapes of one or more pieces of shape memory material.

As an example, one or more pulley arrangements or other arrangements may be included in a shape memory material actuator. For example, consider a pulley where a pulley line is made of shape memory material and/or operatively coupled to shape memory material. In such an example, a change in shape of the material can cause the line to lengthen and/or shorten, which can cause the pulley to rotate while the line may be maintained at an angle or angles with respect to the pulley. As an example, a pulley arrangement can include a block and tackle, for example, assembled so one block is attached to a fixed mounting point and the other is attached to a movable load, directly or indirectly (e.g. consider a load being a valve member, etc.). As an example, one or more mechanisms may be employed to provide for displacement multiplying and/or multiplexing. For example, consider one or more of links, pulleys, etc.

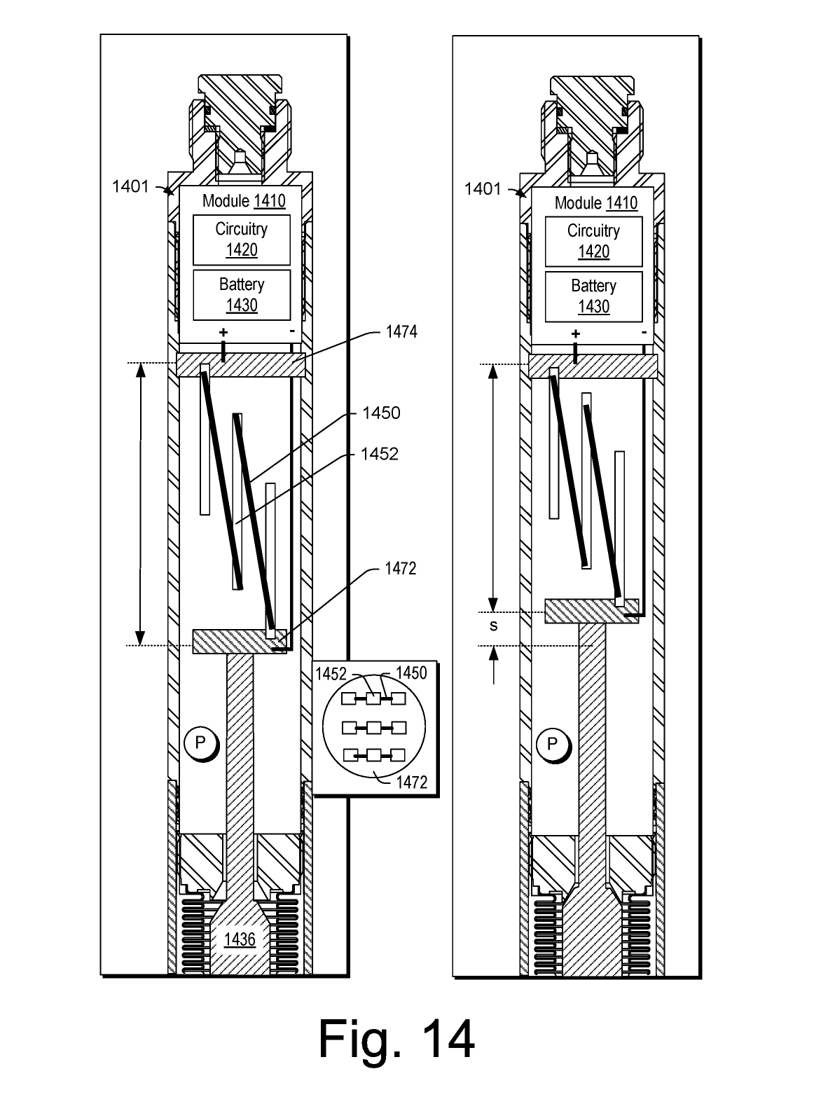

FIG. 14 shows an example of a shape memory material actuator 1401 that includes shape memory material 1450 that is operatively coupled links 1452, where at least one of the links 1452 is operatively coupled to an end member 1372 and where at least another of the links 1452 is operatively coupled to another end member 1474 where alteration in the shape of the shape memory material 1450 can translate a valve member 1436. For example, a current may be applied to the shape memory material 1450 to shorten the overall length of a gang of links 1452 such that the end member 1472 being operatively coupled to the valve member 1436 can translate upwards, for example, against force of a spring, a bellows chamber pressure, etc.

In the example of FIG. 14, the shape memory material actuator 1401 can include a plurality of shape memory material and link sub-assemblies where, for example, at least one piece of shape memory material is disposed between two links. As an example, a link may be a rigid piece of material that may exhibit little to no deformation upon application of force via a change in shape or shapes of one or more pieces of shape memory material.

As shown in the example of FIG. 14, a module 1410 can include circuitry 1420 and one or more batteries 1430. As an example, the module 1410 may be disposed within a gas chamber and/or within a housing operatively coupled to a gas chamber. As an example, a gas chamber can include a shape memory material actuator disposed within, for example, at least in part in a gas chamber space. As an example, a shape memory material actuator may act to reduce an amount of pressure applied to a valve member. For example, in the example of FIG. 14, a chamber pressure P may exert force on the valve member 1436 to maintain a valve in a closed state. In such an example, the force exerted by the shape memory material 1450 can be in an opposite direction such that the amount of force (e.g., pressure) to cause the valve member 1436 to translate upwardly is reduced. In such an example, a shape memory material actuator may act to reduce a valve opening pressure. As an alternative, where a shape memory material actuator can exert force in the same direction as pressure in a chamber, the shape memory material actuator can increase the valve opening pressure.

As an example, a gas lift valve can include one or more shape memory material actuators that can adjust a valve opening pressure (e.g., or a valve closing pressure). For example, one shape memory material actuator may increase the valve opening pressure and another shape memory material actuator may decrease the valve opening pressure. In such an example, circuitry may include control circuitry that can respond to a sensed and/or a communicated signal to selectively cause an increase or a decrease in a valve opening pressure.

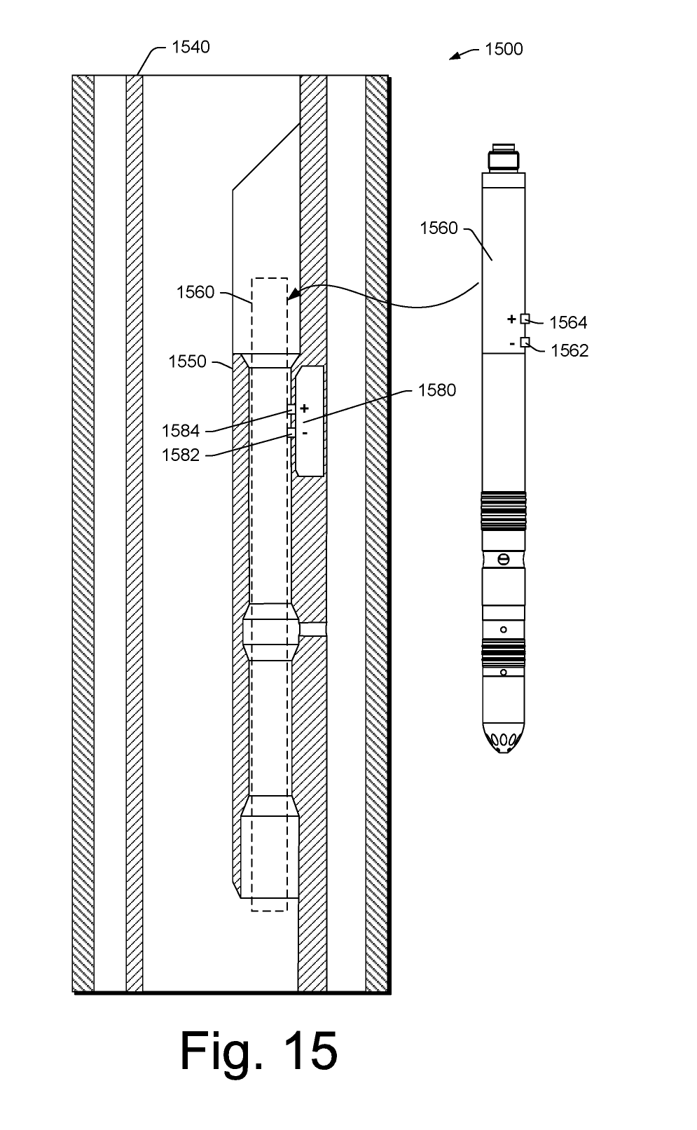

FIG. 15 shows an example of a system 1500 that includes a mandrel 1540 that includes a pocket 1550 that seats a gas lift valve 1560. As an example, the mandrel 1540 can include circuitry 1580, which may include a power supply such as, for example, one or more batteries. As shown, the circuitry 1180 is operatively coupled to connectors 1582 and 1584, which may be disposed in a wall of the pocket 1550. In the example of FIG. 15, the gas lift valve 1560 can include one or more connectors 1562 and 1564 that can be positioned within the pocket 1550 to electrically connect to the connectors 1582 and 1584. In the example of FIG. 15, while two connectors are illustrated, a number of connectors may range from one to more than one. As an example, a connector may be a standardized connector such as, for example, a serial bus connector (e.g., USB, etc.) where power and information may be transmitted. As an example, a connector or connectors may be an interface or interfaces.

As an example, the circuitry 1580 may optionally include one or more sensors and/or one or more receivers. In such an example, information sensed and/or received by the circuitry 1580 may trigger actuation of a shape memory material actuator of the gas lift valve 1560. For example, where a condition is sensed (e.g., pressure, temperature, depth, orientation, etc.), a control signal may be applied to the one or more connectors 1582 and 1584 to cause receipt of the control signal by the one or more connectors 1562 and 1564, which, in turn, cause an adjustment to be made by one of one or more shape memory material actuators of the gas lift valve 1560. As an example, where a signal is received (e.g., a communication, etc.), a control signal may be applied to the one or more connectors 1582 and 1584 to cause receipt of the control signal by the one or more connectors 1562 and 1564, which, in turn, cause an adjustment to be made by one of one or more shape memory material actuators of the gas lift valve 1560.

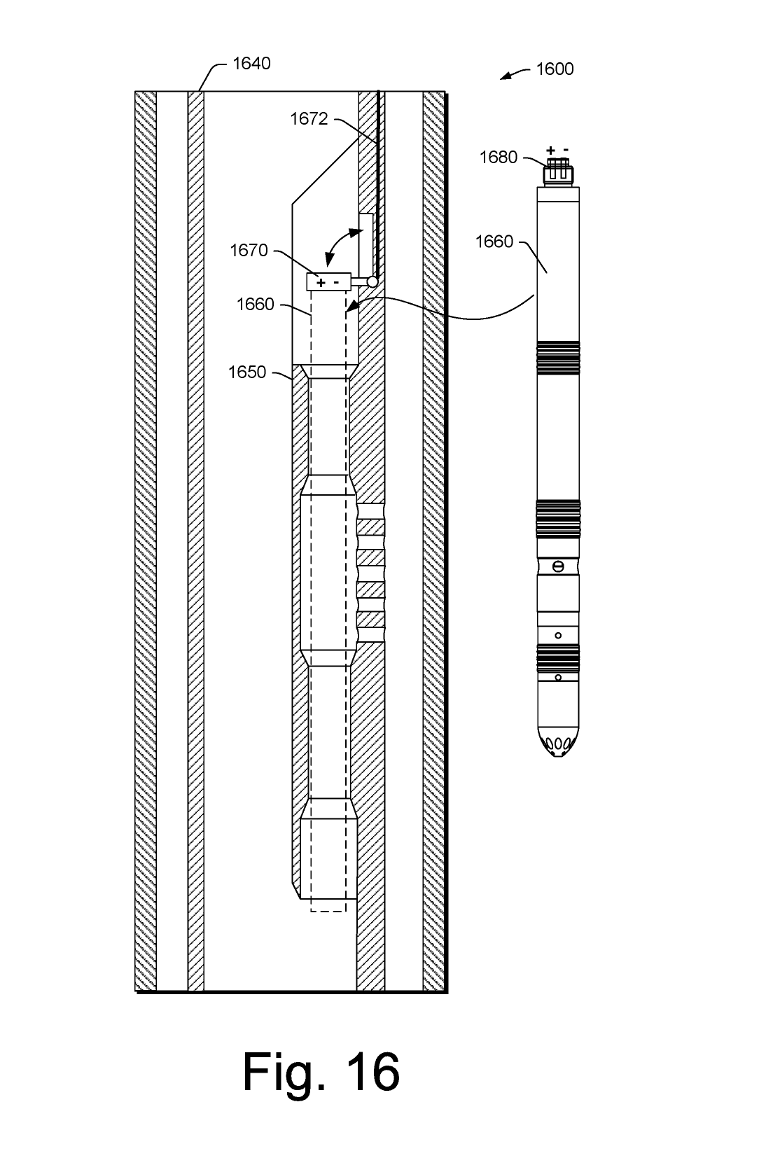

FIG. 16 shows an example of a system 1600 that includes a mandrel 1640 that includes a pocket 1650 that seats a gas lift valve 1660. As an example, the mandrel 1640 can include a connector 1670 operatively coupled to a line 1672 (e.g., one or more wires, etc.), which may provide power and/or signals. In the example of FIG. 16, the gas lift valve 1660 can include one or more connectors 1680 that can be connected to the connector 1670. As an example, a number of connectors may range from one to more than one. As an example, a connector may be a standardized connector such as, for example, a serial bus connector (e.g., USB, etc.) where power and information may be transmitted. As an example, a connector or connectors may be an interface or interfaces.

In the example of FIG. 16, the connector 1670 may be movable to allow for coupling to and decoupling from a gas lift valve. As an example, the connector 1270 may allow for surface equipment (e.g., or other equipment) to provide and/or receive information from the gas lift valve. As an example, the gas lift valve 1660 can include at least one type of shape memory material. In such an example, the gas lift valve 1660 can include at least one shape memory material actuator that can adjust one or more components of the gas lift valve 1660. For example, consider one or more valve actuators that can adjust one or more valve members that may, for example, be adjusted to allow for flow of gas through at least a portion of the gas lift valve 1660 and/or to block flow of gas through one or more portions of the gas lift valve 1660.

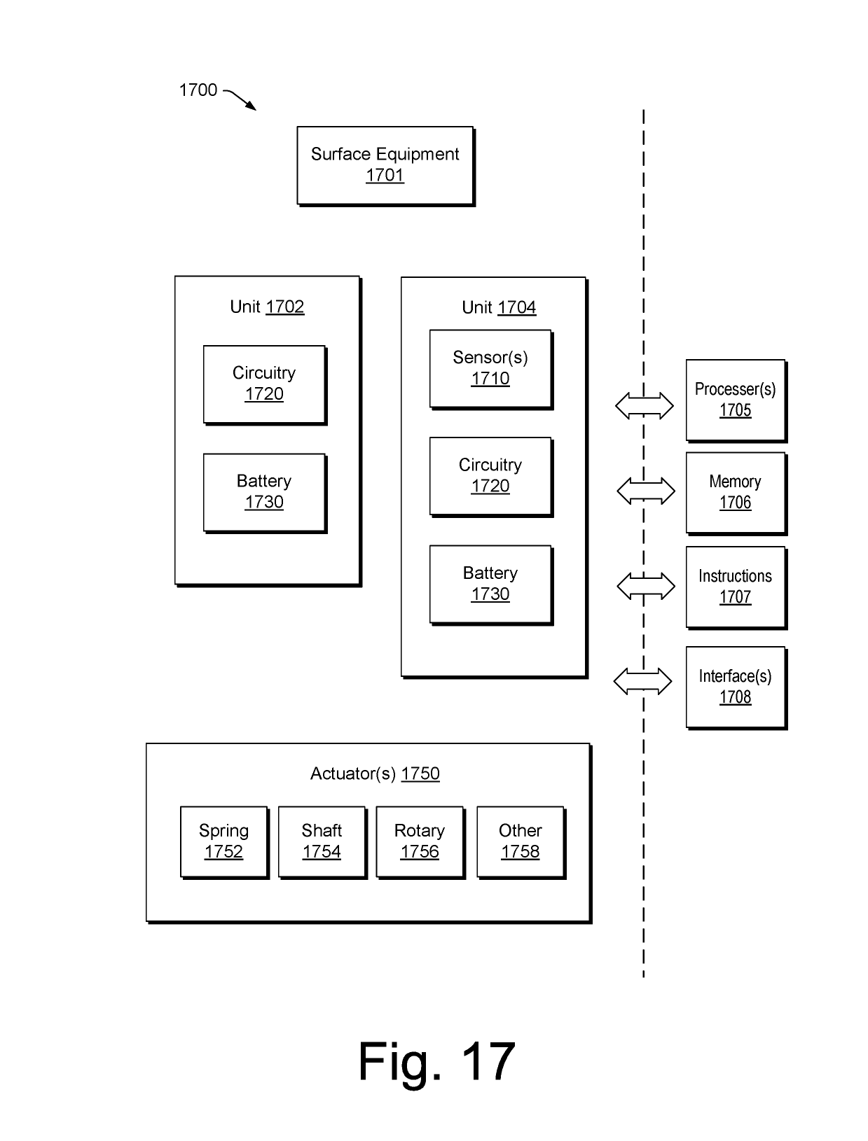

FIG. 17 shows an example of a system 1700 that includes surface equipment 1701, a unit 1702, a unit 1704, one or more processors 1705, memory 1706 accessible by at least one of the one or more processors 1705, instructions 1707 as may be stored in the memory 1706 where the instructions can include processor-executable instructions, one or more interfaces 1708 and one or more actuators 1750. As an example, the unit 1702 can include one or more of circuitry 1720 and one or more batteries 1730. As an example, the unit 1704 can include one or more of one or more sensors 1710, circuitry 1720 and one or more batteries 1730.

As an example, a unit may be part of a shape memory material actuator or may be operatively coupled to a shape memory material actuator. As an example, circuitry can include a timer, for example, to determine a time to actuate, a time to de-actuate, etc. As an example, a sensor can be a depth sensor. As an example, a sensor can be a pressure sensor, optionally a pressure differential sensor. As an example, a sensor can be a motion sensor. As an example, a sensor can be a flow sensor. As an example, a sensor can be a temperature sensor.

As an example, a unit may provide for feedback and, for example, a feedback loop for closed loop control. For example, where a desired valve opening pressure is to be set, a sensor may sense a fluid pressure (e.g., a gas pressure) of fluid that may flow through a gas lift valve in an open state and may adjust current to a shape memory material actuator such that a valve member is actuated at a sensed fluid pressure. In such an example, a unit may calibrate the gas lift valve. As an example, such an approach may be utilized where a valve member may be biased via a spring and/or pressure as in a gas chamber. For example, one or more shape memory material actuators may be able to adjust a valve opening pressure (e.g., and/or valve closing pressure) upwardly or downwardly (e.g., to achieve a desired valve opening pressure).

In the example of FIG. 17, the one or more actuators 1750 are shape memory material actuators that may operate via one or more types of mechanisms that can respond to change in shape of one or more shape memory materials. For example, an actuator may include a spring 1752, a shaft 1754, a rotary member 1756 and/or one or more other types of elements 1758 that can change in shape (e.g., be shape memory material) and/or respond to a change in shape (e.g., of shape memory material). For example, consider one or more of the shapes of the shape memory material actuators 1101, 1201, 1301 and 1401 of FIGS. 11, 12, 13 and 14.

As an example, a unit can be part of a mandrel or part of a gas lift valve. As an example, a gas lift valve may include circuitry while a mandrel includes a battery and/or a gas lift valve may include a battery while a mandrel includes circuitry. As an example, a gas lift valve can include one or more of the actuators 1350. As an example, a mandrel may optionally include one or more actuators that may adjust one or more features of a mandrel such as a pocket feature. For example, consider a mandrel that includes one or more openings that may be adjusted as to flow of gas to a gas lift valve. In such an example, a shape memory material actuator may adjust such one or more openings via one or more iris apertures, one or more sliding covers, etc.

As an example, one or more components of the system 1700 can include a processor. As an example, one or more components of the system 1700 can include memory. As an example, one or more components of the system 1700 can include an interface. As an example, one or more components of the system 1700 can include a processor, memory accessible to the processor and processor-executable instructions stored in the memory that can be executed to control, for example, one or more of the actuators 1750. As an example, one or more of the actuator 1750 can include a unit or units such as the unit 1702 and/or the unit 1704.

As an example, a processor may be a microcontroller such as, for example, an ARM-based microcontroller, a RISC-based microcontroller, etc. As an example, a shape memory material actuator can include a “system on a chip” (SoC). As an example, a gas lift valve can be a “smart” gas lift valve that includes at least one shape memory material actuator controllable by logic, which may be responsive to one or more conditions (e.g., one or more sensed conditions) and/or signals transmitted to the gas lift valve.

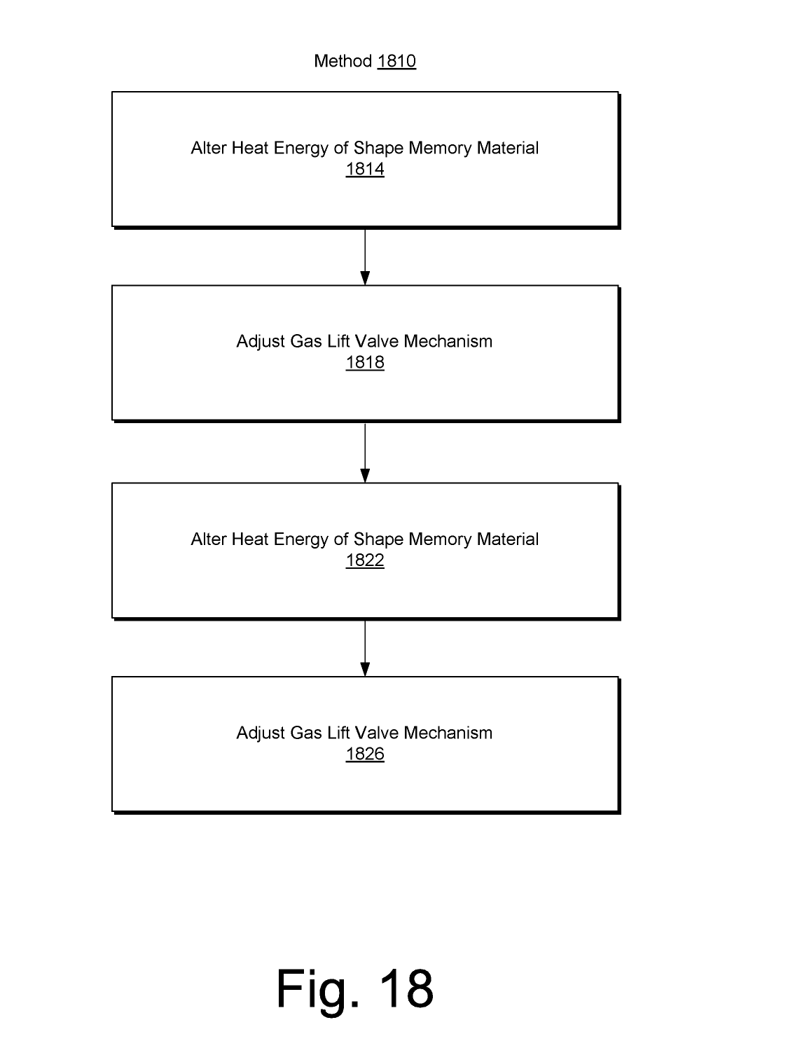

FIG. 18 shows an example of a method 1810 that includes an alteration block 1814 for altering heat energy of a shape memory material of a shape memory material actuator, an adjustment block 1818 for adjusting a gas lift valve mechanism at least in part via the shape memory material actuator, an alteration block 1822 for altering heat energy of the shape memory material, and an adjustment block 1826 for adjusting the gas lift valve mechanism at least in part via the shape memory material actuator.

As an example, an IPO gas lift valve can include a spring loaded back check valve and a gas (e.g., nitrogen) filled bellows. As an example, one or more shape memory alloy (SMA) actuators may be used to replace either, or both of, the spring loaded back check valve and bellows. For example, an IPO gas lift valve can include a SMA actuator in lieu of a spring loaded back check mechanism and a SMA actuator in lieu of a nitrogen filled bellows.

As an example, a gas lift valve can include a nitrogen filled bellows and a SMA actuator (e.g., rather than a spring loaded back check mechanism). As an example, a gas lift valve can include a spring loaded back check mechanism and a SMA actuator (e.g., rather than a nitrogen filled bellows). As an example, a SMA-based actuator may also replace the spring loaded back check actuation mechanism in standard and barrier gas lift valves.

As an example, shape memory material-based actuators can allow for remote wireless operation/control, which may be beneficial for production optimization applications. In some embodiments, as an example, a SMA actuated gas lift valve disposed in a wellbore is in wireless communication with a controller. In such an example, the controller enables manual and/or automated delivery of operational signals to the gas lift valve. For example, the controller may cause one or more signals to be wirelessly transmitted to the gas lift valve to control actuation of the SAM actuator.

As an example, an electronic control system can be operatively coupled to a shape memory material actuator, optionally to provide a wireless remotely controlled system, which may be utilized in a down hole valve control (e.g., such as in gas lift valves). As an example, a shape memory material actuator may add redundancy for increased reliability and flexibility in being able to be custom designed for a wide range of applications.

As an example, a gas lift valve can include shape memory material where circuitry operatively coupled to the shape memory material can cause the shape memory material to alter its shape and, for example, adjust one or more characteristics of a valve, which may be a gas flow valve. For example, consider a multi-state shape memory material where circuitry can cause the multi-state shape memory material to transition from one state to another state where the states correspond to different shapes. As an example, a state can be associated with a phase material. As an example, a state can be associated with a length of a shape memory material. As an example, a state can be associated with an amount of force applied by a shape memory material (e.g., a spring force, etc.).

As an example, a gas lift valve can include a shape memory material actuator; and a valve member operatively coupled to the shape memory material actuator. In such an example, the gas lift valve can include a battery and/or a connector that electrically connects to a power supply.

As an example, a gas lift valve can include a gas inlet opening and a gas outlet opening where a valve member is adjustable for fluidly coupling at least a portion of a gas passage between the gas inlet opening and the gas outlet opening. In such an example, one or more shape memory material actuators may be utilized to adjust the valve member (e.g., directly and/or indirectly).

As an example, a gas lift valve can include a shape memory material actuator that includes control circuitry that controls a current in a circuit that includes shape memory material of the shape memory material actuator.

As an example, a gas lift valve can include a shape memory material actuator that includes a biasing element made at least in part of shape memory material. In such an example, the biasing element can be a tension element or the biasing element can be a compression element. As an example, a gas lift valve can include one or more biasing elements. As an example, a gas lift valve can include at least one tension element and at least one compression element where such elements include shape memory material.

As an example, a gas lift valve can include at least two shape memory material actuators. As an example, a gas lift valve can include a check valve member. As an example, a gas lift valve can include one or more translatable valve members. As an example, a gas lift valve can include a gas flow passage that is controlled via one or more valve members.

As an example, a gas lift valve can be of a substantially cylindrical shape. For example, a gas lift valve can be of a substantially cylindrical shape to be received by a substantially cylindrical bore of a mandrel (e.g., a side pocket mandrel, etc.).

As an example, a gas lift valve can include at least one electrical connector accessible via an outer surface of the gas lift valve. As an example, a gas lift valve can include a sensor operatively coupled to a shape memory material actuator or shape memory material actuators. For example, a sensor may be directly coupled to a shape memory material (e.g., consider a strain gauge, etc.) and/or a sensor may be indirectly coupled to a shape memory material (e.g., via a controller, etc.).

As an example, a system can include a gas lift valve that includes a shape memory material actuator and an electrical connector; and a mandrel that includes circuitry and an electrical connector that electrically connects the circuitry to the electrical connector of the gas lift valve. For example, consider a side pocket mandrel that includes a bore that can receive at least a portion of the gas lift valve to operatively couple the electrical connectors. As an example, circuitry can include a battery. As an example, circuitry can include a sensor. As an example, circuitry can include a timer. As an example, circuitry can include a microcontroller. As an example, circuitry can include memory and optionally processor-executable instructions stored in the memory that can be executed by a processor, which may be a microcontroller.

As an example, a gas lift valve can be disposed in a mandrel where the gas lift valve includes a valve member operatively coupled to a shape memory material actuator.

As an example, a method can include altering heat energy of a shape memory material of a shape memory material actuator operatively coupled to a valve mechanism of a gas lift valve; responsive to the altering, adjusting the valve mechanism at least in part via the shape memory material actuator; altering heat energy of the shape memory material; and adjusting the valve mechanism at least in part via the shape memory material actuator. In such an example, the altering heat energies can include heating followed by cooling or, for example, cooling followed by heating.

### CONCLUSION

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A gas lift valve comprising:
a shape memory material actuator; and
a valve member operatively coupled to the shape memory material actuator.

2. The gas lift valve of claim 1 comprising a battery.

3. The gas lift valve of claim 1 comprising a gas inlet opening and a gas outlet opening wherein the valve member is adjustable for fluidly coupling at least a portion of a gas passage between the gas inlet opening and the gas outlet opening.

4. The gas lift valve of claim 1 wherein the shape memory material actuator comprises control circuitry that controls a current in a circuit that includes shape memory material of the shape memory material actuator.

5. The gas lift valve of claim 1 wherein the shape memory material actuator comprises a biasing element made at least in part of shape memory material.

6. The gas lift valve of claim 5 wherein the biasing element comprises a tension element.

7. The gas lift valve of claim 5 wherein the biasing element comprises a compression element.

8. The gas lift valve of claim 1 comprising at least two shape memory material actuators.

9. The gas lift valve of claim 1 wherein the valve member comprises a check valve member.

10. The gas lift valve of claim 1 wherein the valve member comprises a translatable valve member.

11. The gas lift valve of claim 1 comprising a substantially cylindrical shape.

12. The gas lift valve of claim 1 comprising at least one electrical connector accessible via an outer surface of the gas lift valve.

13. The gas lift valve of claim 1 comprising a sensor operatively coupled to the shape memory material actuator.

14. A system comprising:
a gas lift valve that comprises a shape memory material actuator and an electrical connector; and
a mandrel that comprises circuitry and an electrical connector that electrically connects the circuitry to the electrical connector of the gas lift valve.

15. The system of claim 14 wherein the gas lift valve comprises a valve member operatively coupled to the shape memory material actuator.

16. The system of claim 14 wherein the circuitry comprises a battery.

17. The system of claim 14 wherein the circuitry comprises a sensor.

18. A method comprising:
altering heat energy of a shape memory material of a shape memory material actuator operatively coupled to a valve mechanism of a gas lift valve;
responsive to the altering, adjusting the valve mechanism at least in part via the shape memory material actuator;
altering heat energy of the shape memory material; and
adjusting the valve mechanism at least in part via the shape memory material actuator.

19. The method of claim 18 wherein the altering heat energies comprise heating followed by cooling.

20. The method of claim 18 wherein the altering heat energies comprise cooling followed by heating.
